(19) United States
(12) Patent Application Publication
(10) Pub. No.: US 2017/0225451 A1
(43) Pub. Date: Aug. 10, 2017

(54) HIGHLY DYNAMIC INK DENSITY CONTROL

(71) Applicant: manroland sheetfed GmbH, Offenbach (DE)

(72) Inventors: Thomas Klassert, Alzenau (DE); Lothar Kuehlmeyer, Darmstadt (DE); Stefan Vogel, Seligenstadt (DE)

(73) Assignee: manroland sheetfed GmbH, Offenbach (DE)

(21) Appl. No.: 15/502,889

(22) PCT Filed: Aug. 7, 2015
(86) PCT No.: PCT/EP2015/068274

§ 371 Date: Feb. 9, 2017

(30) Foreign Application Priority Data
Aug. 9, 2014 (DE) 10 2014 011 865.7
Feb. 3, 2015 (DE) 10 2015 101 497.1

(51) Int. Cl. B41F 31/13; B41F 31/04

(52) U.S. Cl. CPC B41F 31/13; B41F 31/04

(57) ABSTRACT

For accelerated setting of a quantity of ink in an inking unit of an offset printing unit, it is proposed to maximise the quantity of ink transported out of an ink duct of the inking unit over an ink duct roller (1) and a lifting roller (6) into the inking unit during the adjustment of ink metering elements (3) which determine the metering of the ink in terms of the quantity thereof on the ink duct roller.

### TECHNICAL FIELD OF INVENTION

The invention concerns a method for ink density control.

### BACKGROUND OF THE INVENTION

It is known in ink regulation in offset printing machines that a control step leads to a change of the ink metering element settings. In doing so, the amount of ink that must be transported to the roller train of the offset printer that has thus been changed must be transported over a large number of ink rollers before it reaches the printing plate and sets the desired amount of ink there. This transport time results in a number of printed sheets that are not yet properly inked and must be regarded as spoilage.

A method for use on a half-tone multicolor printer in order to achieve a selected printing result on a printing substrate is disclosed in DE 39 04 301 A1. Measurement values in the form of full-tone densities and/or raster densities are obtained from measurement zones printed on the substrate, and deviations of the instantaneous printing results from the preselected printing result are determined from the measurement values. In order to when necessary bring the instantaneous printing result up to the preselected printing result as quickly as possible, the feed of the printing inks, at least to selected inking zones on the substrate, is initially, for a limited period, changed to a greater extent than corresponds to the measured deviations and only afterward set in correspondence with the deviations.

It is disadvantageous that in spite of the zonal change of the ink feed the changed amount of ink must be transported over the plurality of ink rollers and thus a delay arises in the adjustment of the printed amount of ink.

A method and a device for ink feed is disclosed in DE 102 42 278 A1. The method for ink feed and a corresponding roller train for performing the method operate with an ink fountain roller that has a drive and can be driven at presettable rotary speeds, an ink metering system that interacts with the ink fountain roller, a ductor roller that is subordinate to the ink fountain roller and can be moved back and forth between the ink fountain roller and another ink roller by means of a drive, and a control system, which is signal-connected to the ink metering system, the ink fountain roller drive, and the ductor roller.

For a noticeable acceleration of the reaction time of the roller train, the control system is set into operation when the settings of the ink metering system change. In this case the drive of the ink fountain roller is actuated to a higher rotary speed in a period in which the ductor roller does not contact the ink fountain roller.

It is disadvantageous that a changed amount of ink can be delivered only in specific periods and thus the reaction time of the roller train does not decrease significantly.

### BRIEF SUMMARY OF THE INVENTION

An object of the invention is to achieve a faster adjustment of the amount of ink in the roller train in an ink control process and thus to reduce substrate spoilage. Accordingly, according to the invention a highly dynamic ink density control is proposed in which the ink gate opening is increased or decreased above or below the calculated value for a specific period and/or a number of engagements of a ductor roller.

The ink ductor rate of movement and/or the ductor strip width are adjusted to a maximum value or close to the maximum value of 95 to 100%. Through this, the target ink density is achieved much faster than with the known dynamic ink density controls.

The ductor strip width is already changed through the change of the ink ductor rate of movement as long as the engagement time of the ductor roller on the ink fountain roller remains constant. However, the ductor strip can also be adjusted via a change of the engagement time of the ductor roller on the ink fountain roller. Then the adjustment to a maximum value or close to the maximum value of 99 to 100% would also refer to the adjustability of the ductor roller drive with respect to the engagement time.

The invention has the following advantages and avoids the following disadvantages:

a) Faster achievement of the intended ink density

b) The travel path of the ink metering elements is shorter than with traditional dynamic methods.

c) Very large gate openings, which can cause a spray of ink, are avoided.

### BRIEF DESCRIPTION OF THE DRAWINGS

FIG. 1 is a schematic side view of a roller train with control system according to the invention.

FIGS. 2a-c are schematic side views of the roller train of FIG. 1 showing the operation of the invention in the region of ink metering and ink fountain roller.

### DETAILED DESCRIPTION OF THE INVENTION

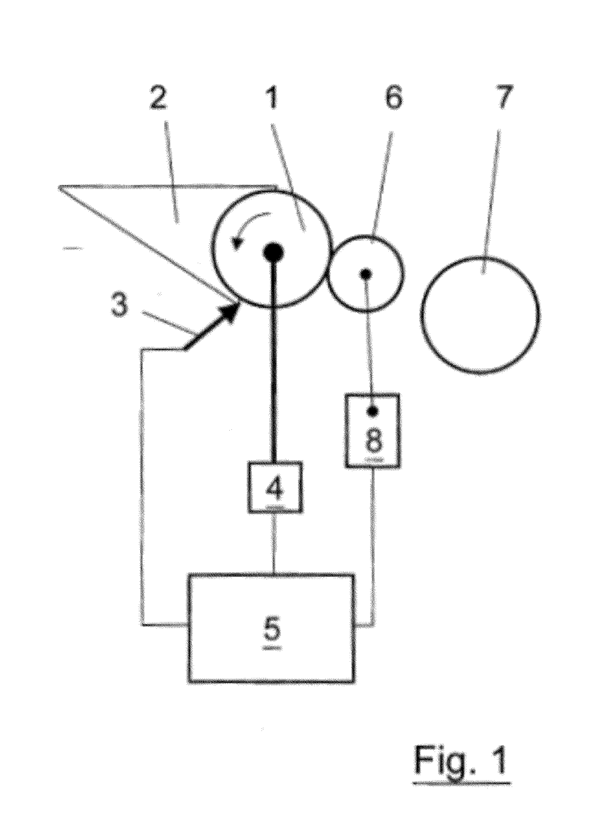

FIG. 1 shows in schematic form the upper part of a ductor roller train of an offset printing machine, which is not shown in its entirety. An ink fountain roller 1, which has a controllable drive 4, interacts with the ink fountain 2. The direction of rotation of the ink fountain roller 1 is indicated by the arrow.

Ink metering elements 3, which are designed, for example, as linearly movable ink gates, each of which has an actuator, are disposed at the lower end of the ink fountain 2.

A ductor roller 6 that moves back and forth between the ink fountain roller 1 and another ink roller 7 is associated with the ink fountain roller 1. The ductor roller 6 has a drive 8. The length of the ink strip picked up by the ductor roller 6 from the ink fountain roller 1 is dependent on the rotary speed of the ink fountain roller 1 and thus can be adjusted by a rotary speed setting of the drive 4.

The drive 4 of the ink fountain roller 1 communicates with a control system 5 and the control system 5 likewise communicates with the ink metering devices 3 and the drive 8 of the ductor roller 6. Through the connection with the drive 8, the length of the engagement time of the ductor roller 6 on the ink fountain roller 1, and also whether the ductor roller 6 is in contact with the ink fountain roller 1, can be determined by the control system 5. This takes place, for example, via a signal transmitter disposed in drive 8, which detects the back and forth movement of the ductor roller 6.

If the ink feed is dynamically changed over the ink metering elements 3 (i.e., during the printing process with operating ink transport) by an input device such as an ink control system (not shown), which communicates with the control system 5, the control system 5 reacts thereon in accordance with the invention in various ways.

According to one embodiment, for the duration of a dynamic adjustment of the ink metering elements 3, the ink fountain roller 1 is speeded up from the preset speed for the current printing situation to a maximum or substantially maximum speed. Through this, the change of the ink layer on the surface of the ink fountain roller 1 caused by changing the metering elements is dynamically implemented and thus comes into direct contact with the ductor roller 6 faster.

For a given constant engagement time of the ductor roller 6 on the ink fountain roller 1, a longer, so-called ductor strip will be produced. This refers to the rolled-out length of the surface of the ductor roller 6 on the ink fountain roller 1. Therefore, if the metering element opening becomes larger, more printing ink will additionally be transported over the subsequent ink rollers into the roller train by the acceleration of the ink fountain roller 1.

On the other hand, if less printing ink is to be transported and the metering element opening is reduced, an acceleration of the return of printing ink from the upper ink fountain rollers to the ink fountain roller 1 through the acceleration of the ink fountain roller 1 during the reduction of the metering element opening is enabled.

When the dynamic adjustment of the ink metering elements 3 has ended, the drive 4 of the ink fountain roller 1 is controlled so that it returns to the previous rate, i.e. the one selected at the ink fountain roller 1 for the intended printing situation.

According to another embodiment, for the duration of a dynamic adjustment of the ink metering elements 3 via the control system 5, the ductor roller 6 can be adjusted via its drive 8 in its back and forth movement to and from ink fountain roller 1 so that the ductor strip width determined by the engagement time on the ink fountain roller 1 is reset from the value provided for the current printing situation to a maximum or substantially maximum value of the ductor strip width. As a result, the change of the ink layer on the surface of the ink fountain roller 1 caused by changing the metering elements goes directly from the ductor roller 6 to the next roller train roller 7. When the dynamic adjustment of the ink metering elements 3 is ended, the drive 8 of the ductor roller 6 is controlled so that it returns to the previous value of the engagement time, the one selected for the intended printing situation, and thus the ductor strip width on the ductor roller 6 returns to the previous value.

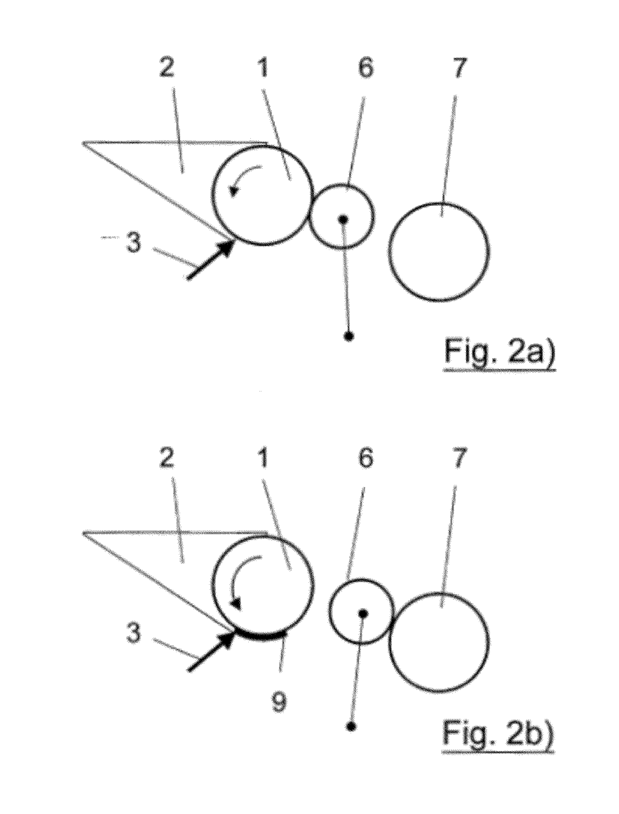

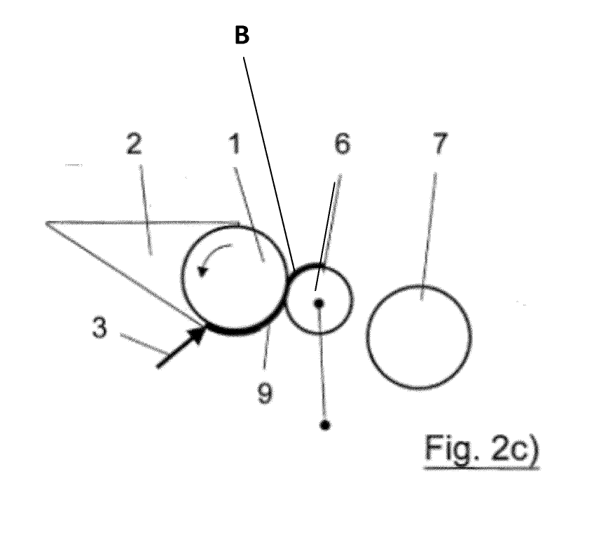

FIGS. 2a)-2c) show the basic operation of the invention. FIG. 2a) shows the situation during the original adjustment of the ink metering elements 3. The ink fountain roller 1 rotates at the speed preset for the printing situation (arrow); the ductor roller 6 oscillates between the ink fountain roller and the next ink roller 7.

In FIG. 2b) a change of the ink metering elements—in this case an increase of the ink feed in the form of a larger gap between the ink metering element 3 and the surface of the ink fountain roller—has been undertaken. This causes a jump in the thickness of ink layer 9 on the ink fountain roller 1. The ductor roller 6 does not contact the ink fountain roller 1. At this point, the speed of the ink fountain roller 1 is increased to 99 to 100% of its maximum speed, so that the thicker ink layer 9 (larger gap) comes into the contact region with the ductor roller 6 faster and especially when the thicker ink layer is in contact with the ductor roller 6. Thus, a thicker and longer ductor strip of printing ink is produced on the ductor roller 6 and transferred from it to the roller train. The increased rotary speed of the ink fountain roller 1 is indicated by the length of the arrow.

It is shown in FIG. 2c) that after the ductor roller 6 contacts the ink fountain roller 1, the change of the ink layer thickness 9 brought about by the change of the ink metering system is now transferred to the ductor roller 6 and then from it, upon contact with the next ink roller 7, to the rest of the rollers of the roller train. The ink fountain roller 1 in this case continuously operates at the maximum or substantially maximum speed until the dynamic adjustment of the ink metering elements 3 is complete.

In FIG. 2c) one can see a second alternative method according to the invention. The ink strip B acquired from the ink fountain roller 1 by the ductor roller 6 is represented as an ink layer lying as the ductor strip width on the circumference of the ductor roller 6. The ductor strip width can, alternatively, be set to a value of 95 to 100% of the maximum value during the dynamic adjustment of the ink metering elements 3. Therefore, according to the invention it is intended that during the time of the dynamic adjustment of the ink metering elements 3, a maximization of the engagement time between the ink fountain roller 1 and the ductor roller 6 should take place.

The adjustment of the speed of the ink fountain roller and the adjustment of the ductor strip width, or the engagement time between the ink fountain roller 1 and the ductor roller 6, can be carried out in combination with each other. In this case the timing of the switching on and off can be coordinated.

However, in any case, the adjustment of the speed of the ink fountain roller 1 and thus the adjustment of the ductor strip width, or the engagement time of the ductor roller 6 on the ink fountain roller 1, can be cancelled after the completion of the dynamic adjustment of the ink metering elements 3.

Then the relevant settings provided for a sufficient ink supply of the roller train preset by an ink control system are set again. Therefore, the ink fountain roller 1 is then again driven at a speed foreseen for the relevant printing situation. Likewise, the ductor roller 6 is again run with a ductor strip width provided for the relevant printing situation.

Basically, it is to be noted that a larger, or longer, ductor strip results from the increase of the speed of the ink fountain roller 1. When a ductor strip width is set on a control panel of a printing machine, a change of the speed of the ink fountain roller is usually undertaken. The ductor strip width and speed of the ink fountain roller are proportional to each other.

In addition, the movement of the ductor roller is usually generated via the main drive of the printing machine, so that it is dependent on its speed. A change of the ductor roller movement per se is relatively complicated. Nevertheless, it can likewise be used to affect the engagement time of the ductor roller on the ink fountain roller by adjusting a ductor roller drive provided for the movement of the ductor roller.

### REFERENCE NUMBER LIST

1 Ink fountain roller
2 Ink fountain
3 Ink metering system
4 Drive (ink fountain roller 1)
5 Control system
6 Ductor roller
7 Ink roller
8 Drive (ductor roller 6)
9 Ink layer
B Ductor roller width

1-10. (canceled)

11. A method for controlling an ink feed of a roller tram of a sheet-fed offset printing machine, the ink feed comprising a ductor roller train, the method comprising the steps of:
providing a printing ink intended for printing from an ink fountain via an ink metering system that interacts with an ink fountain roller, the printing ink being transported further by a ductor roller that oscillates between the ink fountain roller and an associated first inking roller which is the first of a plurality of inking rollers, the ink fountain roller being driven at a preset rotary speed; and
dynamically adjusting the ink metering system by setting an amount of ink transported from the ink fountain roller via the ductor roller to the first inking roller to a substantially maximum value for a duration of the dynamic adjustment of the ink metering system.

12. The method as in claim 11, wherein when dynamically adjusting the ink metering system, the speed of the ink fountain roller is set to a substantially maximum value for the duration of the dynamic adjustment of the ink metering elements.

13. The method as in claim 12, wherein the speed of the ink fountain roller is set to a value of 99 to 100% of the maximum speed.

14. The method as in claim 11, when dynamically adjusting the ink metering system, a ductor strip width or an engagement time of the ductor roller on the ink fountain roller is set to a substantially maximum value by a drive of the ductor roller for a duration of the dynamic adjustment of the ink metering system.

15. The method as in claim 14, wherein the ductor strip width or the engagement time of the ductor roller on the ink fountain roller is set to a value of 95 to 100% of the maximum ductor strip width or the maximum engagement time of the ductor roller on the ink fountain roller achievable via the ductor drive.

16. The method as in claim 11, wherein when dynamically adjusting ink metering system, the speed of the ink fountain roller is set to a substantially maximum value for the duration of the dynamic adjustment of the ink metering elements and a doctor strip width or an engagement time of the ductor roller on the ink fountain roller is set to a substantially maximum value by a drive of the doctor roller for a duration of the dynamic adjustment of the ink metering system.

17. A roller train for a sheet-fed offset printing machine comprising:
an ink fountain roller having an associated first drive that is drivable at preset rotary speeds;
an ink metering system that interacts with the ink fountain roller via an ink metering, system;
a ductor roller associated with the ink fountain roller, the ductor roller being movable by a second drive back and forth between the ink fountain roller and a first ink roller that is the first of a plurality of rollers; and
a control system in communication with the ink metering device and the first drive wherein the control system is configured to adjust via the first drive the speed of the ink fountain roller to a substantially maximum value by the control system during a dynamic adjustment of the ink metering system for a duration of the dynamic adjustment of the ink metering system.

18. The roller train as in claim 17, wherein the first drive is configured report to the control system a rotary speed of the ink fountain roller in dependence on a function setting with respect to movement of the ink metering system when the ink met system is adjusted.

19. A roller train for a sheet-fed offset printing machine comprising:
an ink fountain roller having an associated first drive that is drivable at preset rotary speeds;
an ink metering system that interacts with the ink fountain roller via an ink metering system;
a ductor roller associated with the ink fountain roller, the ductor roller being movable by a second drive back and forth between the ink fountain roller and a first ink roller that is the first of a plurality of rollers; and
a control system in communication with the ink metering device and the first drive, wherein the control system is configured to adjust via the second drive a ductor strip width of the ductor roller or an engagement time of the ductor roller on the ink fountain roller for drawing ink from the ink fountain roller to a substantially maximum value during a dynamic adjustment of the ink metering system for a duration of the dynamic adjustment of the ink metering system.

20. The roller train as in claim 19, wherein the second drive communicates to the control system a position of the ductor roller with respect to the ink fountain roller and a function setting with respect to movement of the ink metering system when the ink metering system is adjusted.
